(19) United States
(12) Patent Application Publication
(10) Pub. No.: US 2020/0347261 A1
(43) Pub. Date: Nov. 5, 2020

(54) VEHICLE SUSPENSION ELEMENT PROVIDED WITH A COATING, METHOD FOR DEPOSITING SAID COATING AND COATING COMPOSITION FOR THIS METHOD

(71) Applicant: SOGEFI SUSPENSIONS, GUYANCOURT (FR)

(72) Inventor: Dominique DERAM, DOUAI (FR)

(21) Appl. No.: 16/958,219

(22) PCT Filed: Dec. 28, 2018
(86) PCT No.: PCT/FR2018/053567

§ 371 Date: Jun. 26, 2020

(30) Foreign Application Priority Data
Dec. 29, 2017 (FR) 17 63414

(51) Int. Cl. C09D 163/00; C09D 7/40; C09D 7/61; C09D 5/03; C09D 5/08; F16F 1/02; B60G 11/14; F16F 1/06; B60G 21/055; B05D 1/06

(52) U.S. Cl. CPC C09D 163/00; C09D 7/70; C09D 7/61; C09D 7/69; C09D 5/033; C08K 3/36; F16F 1/024; B60G 11/14; F16F 1/06; B60G 21/055; B05D 1/06; C09D 5/08

(57) ABSTRACT

A process for depositing a coating on a suspension element is provided. The process comprises: providing the suspension element to be coated; preheating the surface of the suspension element to a preheating temperature at least equal to 80° C.; depositing on the preheated surface of the suspension element a cross-linkable composition comprising an epoxy compound; and heating the surface of the suspension element to a temperature greater than the preheating temperature so as to cross-link the composition, therefore resulting in the coating.

### FIELD OF THE INVENTION

The present presentation relates to a vehicle suspension element provided with a coating, a process for depositing this coating and a coating composition for this process.

### TECHNOLOGICAL BACKGROUND

Most vehicle suspensions currently on the market comprise springs which are generally helicoidal.

These springs, which are stressed very strongly mechanically, are most often made of steel. Consequently, it is imperative for them to be protected against corrosion, otherwise corrosion of the steel would result in a loss of function of the spring, then in its catastrophic rupture.

For this purpose, these springs are provided with a coating covering the steel and protecting it from corrosion.

This coating must have excellent mechanical resistance and excellent adhesion to the steel of the spring at the same time. The mechanical resistance is necessary to guarantee that the coating resists pitting, that is, repeated impact at high speed by gravel (the size of which can be of the order of a centimetre). Resistance to pitting is measured by standardised pitting test protocols, such as the SAE 3400 protocol.

Adhesion to the steel of the spring is necessary to guarantee that the coating stays in place on the spring even if it is damaged and/or thinned. If the mechanical resistance and/or adhesion of the coating is insufficient, the steel of the spring risks being exposed, inevitably resulting in very rapid corrosion of the steel, in particular in winter when the vehicle is exposed to both humidity and salt used for salting roads. Also, since vehicle suspensions currently on the market are not provided for their springs to be replaced frequently, the coating must keep its mechanical resistance and its adhesion properties over a very long period, which corresponds substantially to the expected shelf life of the spring itself.

Various coatings are known for this purpose.

First, coatings are known constituted by a single layer of epoxy or epoxy/polyester paint deposited on the surface of the spring (which can optionally have undergone previous surface treatment) then hardened, and the average thickness of which is typically between 35 μm and 200 μm.

These coatings are adequate only for producing moderate resistance to pitting, corresponding to use in temperate climates and on good-quality roads. They are insufficient for use in more difficult conditions: extreme climates (especially very cold), degraded roads (especially strongly gravelly), a spring strongly stressed mechanically, etc.

For these more difficult conditions of use coatings are known constituted by a first layer of paint deposited on the surface of the spring (which can optionally have undergone previous surface treatment) and an average thickness typically of the order of 50 μm, and a second layer of paint different in composition, deposited on the first layer of paint and an average thickness typically of the order of 200 μm.

To produce these coatings it is necessary to have the spring to be coated pass successively through a minimum of two separate application stations, increasing the amount of equipment, handling and total time necessary for coating the spring, and this is a disadvantage in terms of costs. Also, to achieve the preferred shelf life it can also be imperative to increase the thickness of the first layer and/or of the second layer of paint, likewise a disadvantage in terms of costs.

Despite the above disadvantages, these coatings are still in use today, as it has proved impossible to date to obtain a coating which is satisfactory in difficult conditions of use and is constituted by a single layer.

There is therefore a real need for a process for depositing a coating which would produce a coating satisfactory in difficult conditions of use and be constituted by a single layer.

### PRESENTATION OF THE INVENTION

This presentation relates to a vehicle suspension element provided with a coating, the coating comprising a reticulated polymer matrix comprising a polyepoxide and having a minimum thickness at least equal to 120 μm. In some embodiments the coating has a minimum thickness at least equal to 200 μm.

In some embodiments the coating is constituted by a single layer deposited in a single depositing step.

In some embodiments in the reticulated polymer matrix the coating comprises:
a fibre filler of average length by number at least equal to 100 μm;
a silica filler having a median diameter in mass at least equal to 1 μm;
a first ceramic filler having a median diameter in mass between 30 μm and 70 μm; and
a second ceramic filler having a median diameter in mass at least equal to 10 μm.

The median diameter in mass, currently noted “Dw50” or more simply “D50”, is a magnitude current in granulometric analysis. It is simply recalled here that the median diameter in mass of a sample of particles is the particle diameter such that 50% of the mass of this sample is constituted by particles of a size less than or equal to this diameter.

Granulometric analysis methods for determining the median diameter in mass are well known. For example, the median diameter in mass can be measured by screening.

Due to their relative length, the fibres constitute a macroscopic network in the reticulated polymer matrix of the coating. Being of relatively small size relative to the fibres, the particles of the two ceramic fillers densify this macroscopic network, further improving the mechanical resistance of the coating. Finally, since they are even smaller in size, the particles of the silica filler further densify this macroscopic network and their considerable hardness gives the coating substantial resistance to compression during impact by gravel.

These different factors interact to impart to the coating resistance to pitting clearly greater than for coatings known to date, for the same coating thickness. It is therefore possible to decrease the coating thickness to be deposited by conserving the same shelf life of the coating, or else increase the shelf life of the coating for the same coating thickness.

In some embodiments said average length by number of the fibre filler is between 100 μm and 150 μm.

In some embodiments the fibres of the fibre filler have a length between 100 μm and 150 μm.

In addition to giving the coating resistance to pitting clearly greater than coatings known to date, for the same coating thickness the fibres of this length are sufficiently short to retain a smooth and glossy appearance of the coating.

In some embodiments the fibres of the fibre filler have a diameter between 3 μm and 4 μm.

In some embodiments, between the coating and the surface of the suspension element, the suspension element comprises a layer of phosphate crystals, the phosphate crystals having an average size by number at most equal to 20 μm, and preferably at most equal to 10 μm.

The layer of phosphate crystals formed during this step greatly improves adhesion of the reticulated polymer matrix to the surface of the suspension element.

In some embodiments, between the coating and the layer of phosphate crystals, the element comprises a layer of silanes and/or of substituted silanes.

The layer formed during this step further improves adhesion of the matrix of cross-linked polymer to the surface of the spring.

In some embodiments the surface mass of the layer of phosphate crystals is between 1.5 g/m² and 4 g/m², and preferably between 2.0 g/m² and 3.5 g/m².

In some embodiments the suspension element is a spring for suspension, for example a helicoidal spring, or a cambered stabilising bar, or a straight bar.

In some embodiments the suspension element is made of steel.

In some embodiments the minimum thickness of the coating is at most equal to 1200 μm.

This presentation also relates to a process for depositing a coating on a vehicle suspension element, the process comprising the steps of:

providing of the suspension element to be coated;

preheating of the surface of the suspension element to a preheating temperature at least equal to 80° C.;

depositing on the preheated surface of the suspension element of a cross-linkable composition comprising an epoxy compound; and

heating of the surface of the suspension element so as to cross-link the composition, therefore resulting in the coating, the resulting coating having a minimum thickness at least equal to 120 μm. In some embodiments the preheating temperature is at least equal to 100° C., and/or the coating has a minimum thickness at least equal to 200 μm.

“Cross-linkable composition” means designating a composition comprising at least one monomer and at least one hardener, and which is able to cross-link (or harden), under the effect of heat, this reaction being irreversible and resulting in the formation of a cross-linked polymer. A cross-linkable composition can also comprise one or more additives and/or one or more fillers. “Epoxy compound” means designating a chemical compound comprising at least two functional epoxy groups and capable of forming a polyepoxide under the effect of heat and in the presence of a hardener.

In some embodiments the cross-linkable composition comprises:
a fibre filler of average length by number at least equal to 100 μm;
a silica filler having a median diameter in mass at least equal to 1 μm;
a first ceramic filler having a median diameter in mass between 30 μm and 70 μm; and
a second ceramic filler having a median diameter in mass at least equal to 10 μm.

In some embodiments said temperature greater than the preheating temperature is at most equal to 200° C.

In some embodiments, prior to the depositing step, the process also comprises a phosphating step resulting in the formation, on the surface of the suspension element, of a layer of phosphate crystals, the phosphate crystals having an average size by number at most equal to 20 μm, and preferably at most equal to 10 μm.

In some embodiments said phosphating step is performed prior to the preheating step.

In some embodiments, after the phosphating step, the process also comprises a passivation step resulting in the formation of a layer of silanes on the phosphate crystals.

In some embodiments said passivation step is performed prior to the preheating step.

In some embodiments the cross-linkable composition is in the form of powder prior to the depositing step.

In some embodiments with the cross-linkable composition being in the form of powder prior to the depositing step, depositing said powder on the surface of the suspension element is done by electrostatic projection.

In some embodiments the cross-linkable composition also comprises at least one anticorrosion agent.

The presence of one or more anticorrosion agents retards or prevents the progression of any local corrosion of steel under the coating, which in time could damage the coating itself.

Preferably, the anticorrosion agent is devoid of any zinc element, which decreases the impact of the process on the environment. More preferably still, the cross-linkable composition is devoid of any zinc element.

In some embodiments the epoxy compound is based on bisphenol A.

“Bisphenol A” designates 4,4′-dihydroxy-2,2-diphenyl propane. This chemical compound is also known by BPA, 2,2-bis(4-hydroxyphenyl)propane, 4,4′-(propan-2-ylidene)diphenol, or even p,p′-isopropylidenebisphenol.

The process described hereinabove has the same advantages as the vehicle suspension element described hereinabove.

This presentation also relates to a cross-linkable composition for a coating for vehicle suspension element, in which the cross-linkable composition comprises:
an epoxy compound;
a fibre filler of average length by number at least equal to 100 μm;
a silica filler having a median diameter in mass at least equal to 1 μm; and
a first ceramic filler having a median diameter in mass between 30 μm and 70 μm;
a second ceramic filler having a median diameter in mass at least equal to 10 μm; and
a hardener able to have the composition cross-link when the composition is heated. The cross-linkable composition can also comprise an accelerator.

### BRIEF DESCRIPTION OF DRAWINGS

The appended drawings are schematic and aim especially to illustrate the principles of the invention.

In these drawings from one figure to another identical elements (or parts of an element) are marked by the same reference numerals.

FIG. 1 is a view in perspective of a vehicle suspension element according to this presentation.

FIG. 2 is a block diagram showing the steps of a process for depositing the coating of the spring of FIG. 1, which process is according to this presentation.

FIG. 3 is a view in partial section according to III-III of the suspension element of FIG. 1.

### DETAILED DESCRIPTION OF THE INVENTION

To describe the invention more specifically, examples of a vehicle suspension element and examples of a process for depositing a coating on a vehicle suspension element are described in detail hereinbelow, in reference to the appended drawings. It is recalled that the invention is not limited to these examples.

“Vehicle suspension element” means any element able to be installed in a vehicle suspension (not shown) to contribute to the road holding ability of the vehicle, such as for example a spring for vehicle suspension, a cambered stabilising bar (also called anti-slope bar or anti-roll bar) or even a straight bar. In the following, the case will be described where the vehicle suspension element is a spring for vehicle suspension, given that the following can be generalised easily for any vehicle suspension element. The process for depositing a coating described here is particularly useful when the vehicle suspension element is exposed to pitting when the vehicle is moving.

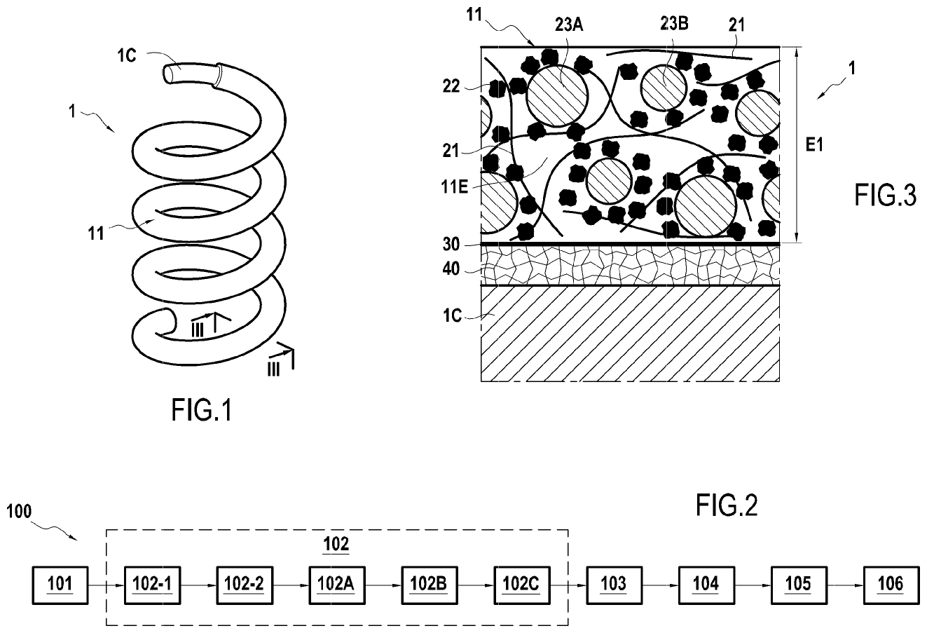

FIG. 1 is a view in perspective of a spring 1 for vehicle suspension.

The spring 1 is able to be installed in a vehicle suspension (not shown). To do this, the ends of the spring 1 are able to be taken up in corresponding cups (not shown), as is known.

In the example shown, the spring 1 is a helicoidal spring. In other examples (not shown), the spring 1 is a non-helicoidal spring, such as a leaf spring.

In the example shown, the spring 1 is made of steel. In other examples (not shown), the spring 1 is made of a metal alloy other than steel. In yet other examples (not shown), the spring 1 is made of composite material. It is specified here that any vehicle suspension element according to this presentation can be made of steel, a metal alloy other than steel, or composite material.

In the appended drawings the steel constituting the spring 1 bears the reference 1C.

The spring 1 is provided with a coating 11. The coating 11 covers the steel 1C of the spring 1 and accordingly protects it from corrosion. Also, the coating 11 is able to resist pitting. Even though FIG. 1 shows that part of the steel 1C is not covered by the coating 11, in practice the whole spring 1 is provided with the coating 11, except optionally those zones necessary for installation of the spring 1 in a conveyance system during the process 100 described later.

The thickness of the coating 11 may or may not be variable along the spring 1. In any case, the coating 11 has a minimum thickness E1 at least equal to 120 μm. The minimum thickness E1 can be at least equal to 200 μm.

In this presentation, the expressions “at least equal to X”, “at most equal to Y”, “between X and Y” encompass the external values X and Y.

The coating 11 has a minimum average thickness preferably at least equal to 250 μm, more preferably at least equal to 350 μm, more preferably still at least equal to 450 μm, even more preferably at least equal to 500 μm, and most preferably at least equal to 700 μm.

The coating 11 comprises a reticulated polymer matrix 11E (which below could be designated simply by “the matrix 11E” for convenience). The matrix 11E comprises a polyepoxide. This matrix 11E has the advantage of exhibiting excellent mechanical resistance, and especially good resistance to pitting as will be detailed later. It also has excellent adhesion to the steel 1C of the spring 1. The matrix 11E can be constituted by a mixture of polyepoxides or a single polyepoxide.

FIG. 2 is a block diagram showing the steps of a process 100 for depositing the coating 11 on the spring 1.

The process 100 comprises a step 101 for providing the spring to be coated. More specifically, the spring 1 is provided non-coated. For example, if the spring 1 is made of steel the spring 1 is provided after the shaping of the steel 1C, which shaping will have optionally been followed by a shot peening step.

The process 100 also comprises a step 103 for preheating of the surface of the spring 1.

More specifically, during the preheating step 103 the surface of the spring is heated to a preheating temperature selected in advance. During the preheating step 103, the surface of the spring 1 can be heated by projection of heated and/or by infrared, for example.

The preheating temperature is at least equal to 80° C. The preheating temperature can be at least equal to 100° C. The preheating temperature is preferably at least equal to 120° C., more preferably still at least equal to 130° C., and even more preferably at least equal to 140° C.

The process 100 also comprises a step 104 for depositing on the surface of the spring 1 a cross-linkable composition comprising an epoxy compound. The depositing step 104 is performed after the preheating step 103. Therefore, on completion of the depositing step 104 the preheated surface of the steel 1C is covered with cross-linkable composition, non-cross-linked or very slightly cross-linked.

Due to the preheating step 103 the matrix 11E is more strongly cross-linked, giving the coating 11 better general mechanical resistance, and in particular excellent resistance to pitting.

In some embodiments the cross-linkable composition is in the form of powder prior to the depositing step 104. Depositing of the cross-linkable composition in the form of powder on the surface of the spring 1 can be done by soaking in a fluidised bath, or else by electrostatic projection, for example by electrostatic projection with corona or triboelectric effect. The methods of electrostatic projection of powders are well known and are therefore not described in detail here. When the cross-linkable composition is in the form of powder, the fact that the surface of the spring 1 is preheated on completion of the preheating step 103 has the powder gel, improving the wetting of the surface of the spring 1 and therefore adherence of the coating 11 to the surface of the spring 1. Also, the preheating step 103 deposits a considerable thickness of coating 11, ranging as far as a minimal thickness of 1200 μm, on the spring 1.

The process 100 also comprises a step 105 for heating of the surface of the spring 1. More specifically, the surface of the spring 1 covered by cross-linkable composition is heated to a temperature sufficient to cross-link the cross-linkable composition, over sufficient time. This temperature is greater than the preheating temperature of the preheating step 103. In other terms, during the heating step 105 the surface of the spring 1 is heated to a temperature greater than the preheating temperature. In any case, on completion of the heating step 105, the cross-linkable composition is cross-linked, therefore resulting in the coating 11 comprising the matrix 11E, and the resulting coating 11 has a minimum thickness at least equal to 120 μm. The minimal thickness can be at least equal to 200 μm.

In some embodiments the coating 11 is constituted by a single layer deposited in a single depositing step. In other terms, in the process 100 there is no depositing step other than the depositing step 104, and the coating 11 obtained on completion of the heating step 105 has a single layer of material only.

During the heating step 105, the surface of the spring 1 can be heated by heated air spraying and/or by infrared, for example. Also, the heating step 105 may or may not be performed by way of the same heating means as the preheating step 103.

In some embodiments during the heating step 105 the surface of the spring 1 is heated to a temperature between 140° C. and 200° C., preferably between 140° C. and 190° C., more preferably still between 150° C. and 180° C. In a preferred embodiment the surface of the spring 1 is heated to a temperature of 140° C., and the cross-linkable composition is likely to be cross-linked to a temperature of 140° C., limiting power consumption of the heating step 105.

As mentioned previously, the cross-linkable composition is able to be cross-linked. The cross-linkable composition therefore also comprises, apart from epoxy compound, a hardener for allowing the cross-linkable composition to cross-link. The hardener can be a single chemical compound or a mixture of chemical compounds able to result in formation of the preferred polyepoxide. For example, the hardener is bisphenol A, dicyandiamide (C₂H₄N₄), ortho-tolylbiguanide, a carboxylic polyester, or a mixture of the latter. The proportion of hardener stoichiometrically relative to the epoxy compound can be between 70% and 100%. Preferably, the hardener is present in the cross-linkable composition in stoichiometric or substantially stoichiometric proportions with the epoxy compound.

Also, the cross-linkable composition typically comprises an accelerator for decreasing the time necessary for reticulation of the composition.

Preferably, the cross-linkable composition is devoid of any 2-methylimidazole to limit the impact of the process 100 on the environment.

In some embodiments the epoxy compound is based on bisphenol A. “Based on bisphenol A” means that the epoxy compound is obtained by reaction of bisphenol A with an epoxidation compound. For example, the epoxy compound is obtained by reaction of bisphenol A with epichlorhydrin.

The cross-linkable composition can have an epoxy equivalent weight (EEW) between 750 and 850 g/equiv., for example equal to around 800 g/equiv.

The process 100 also comprises a step 106 for cooling the spring 1. After the cooling step 106, the spring 1 coated with the coating 11 can be handled, and in particular can be installed in a vehicle suspension.

The cross-linkable composition can also comprise additives and/or fillers.

In particular, the cross-linkable composition can comprise at least one anticorrosion agent to better protect the steel 1C against corrosion. Preferably, the anticorrosion agent is devoid of any zinc element (Zn) to limit the impact of the process 100 on the environment. More preferably still, the cross-linkable composition is devoid of any zinc element (Zn).

Also, the cross-linkable composition can comprise between 0.5% and 1.0% in mass of carbon black. The cross-linkable composition can also comprise barium sulfate for improving its consistency and/or modifying its opacity, and/or can also comprise calcium carbonate.

By way of FIG. 2 an example of fillers which can be contained in the cross-linkable composition to improve the mechanical properties of the coating 11 will now be described.

In this example, the cross-linkable composition comprises:
a fibre filler;
a silica filler;
a first ceramic filler; and
a second ceramic filler.

The fibres of the fibre filler have an average length by number at least equal to 100 μm. Said average length by number can be between 100 μm and 150 μm. Optionally, the fibres of the fibre filler can have a length between 100 μm and 150 μm, and/or a diameter between 3 μm and 4 μm.

The silica filler has a median diameter in mass at least equal to 1 μm. Preferably, the silica filler has a median diameter in mass at least equal to 10 μm, and for example equal to 15 μm. The particles of the silica filler can have a Mohs hardness of 7. The maximal particle size of the silica filler is preferably at most equal to 100 μm, and for example equal to 70 μm.

The first ceramic filler has a median diameter in mass between 30 μm and 70 μm. Preferably, the first ceramic filler has a median diameter in mass between 40 μm and 60 μm, and for example equal to 55 μm. The maximal particle size of the first ceramic filler is preferably at most equal to 110 μm. The minimal particle size of the first ceramic filler is preferably at least equal to 10 μm.

The second ceramic filler has a median diameter in mass at least equal to 10 μm, and for example equal to 15 μm. The median diameter in mass of the silica filler and of the second ceramic filler can be equal. The maximal particle size of the second ceramic filler is preferably at most equal to 60 μm. The minimal particle size of the second ceramic filler is preferably at least equal to 10 μm.

As mentioned hereinabove, the median diameters in mass mentioned hereinabove can be measured by screening. For example, the median diameters in mass mentioned hereinabove can be measured by screening according to the standard NF P18-560. The standard NF P18-560 is available from the French Standardisation Association (AFNOR).

The fibre filler can be a metal fibre filler, a carbon fibre filler, or an organic fibre filler, for example an aramid fibre filler, such as Kevlar (registered trademark). The fibre filler can be a mineral fibre filler, which can be synthetic or not. “Mineral fibres” means designating inorganic non-metallic fibres. For example, the fibre filler can be a ceramic fibre filler, a fibre filler comprising the element boron, or a glass fibre filler.

The silica filler can be constituted by at least 80% in mass of silica (SiO₂), the rest being constituted by inevitable impurities (Al₂O₃, CaO, Fe₂O₃ . . . ). Preferably, the silica filler is constituted by at least 90% in mass of silica, more preferably still by at least 95% in mass of silica, and more preferably still by at least 99% in mass of silica, the rest being constituted by inevitable impurities. The fewer impurities the silica filler contains, the greater its hardness, which reinforces the coating 11 even more.

The first and/or the second ceramic filler can be ceramic ball fillers. Ceramic balls are preferably spherical or substantially spherical. For example, the first and/or the second ceramic filler are fillers of borosilicate glass balls. Borosilicate glass balls have considerable hardness, which boosts resistance to pitting of the coating 11. The first and/or the second ceramic filler can also be fillers of balls constituted by a mixture of zircon (ZrO₂) and silica (SiO₂) and inevitable impurities.

FIG. 2 highly schematically illustrates the coating 11 obtained from the cross-linkable composition described hereinabove, once this composition has been cross-linked.

With the composition being cross-linked, the coating 11 comprises the matrix 11E already described hereinabove.

The fibres 21, the particles of silica 22 of the silica filler, and the particles of the two ceramic fillers are trapped in the matrix 11E. In the example shown, the ceramic particles of the first and second fillers respectively bear the references 23A and 23B.

It is specified here that FIG. 3 is not to scale and that some dimensions, and especially those of the particles of fillers described hereinabove, have been exaggerated or diminished to improve legibility of the drawing.

Also, although the fibres or particles of the different fillers are shown in FIG. 3 as all having the same length or particle size, their length or particle size in reality has some variance about the average lengths or median particle diameters described hereinabove.

As illustrated highly schematically in FIG. 3, the fibres 21 constituent a macroscopic network of fibres in the matrix 11E.

Since they are relatively small in size relative to the fibres 21, the ceramic particles 23A and 23B densify the macroscopic network of fibres 21. Also, since the two ceramic fillers have different distributions of particle size, the particles of one of these fillers substantially fill the spaces left in the macroscopic network of fibres 21 by the particles of the other ceramic filler, further densifying the macroscopic network of fibres 21. This improves the mechanical resistance of the coating 11.

Being of smaller size than the ceramic particles 23A and 23B, the particles of silica 22 substantially fill the spaces left in the macroscopic network of fibres 21 by the ceramic particles 23A, and 23B, even further densifying the macroscopic network of fibres 21. This further improves the mechanical resistance of the coating 11.

Finally, due to their small size, the particles of silica 22 tend to be present in the immediate vicinity of the surface of the coating 11.

Since they have considerable hardness, they therefore give the coating 11 substantial resistance to compression during impact by gravel.

These different factors interact to give the coating 11 resistance to pitting clearly more substantial than coatings known to date for the same coating thickness. It is therefore possible to decrease the coating thickness to be deposited by preserving the same shelf life of the coating, or else increase the shelf life of the coating for the same coating thickness.

When the fibres 21 have a length between 100 μm and 150 μm as mentioned hereinabove, the fibres 21 are sufficiently short to keep a smooth and glossy appearance to the coating 11.

Different optional steps which can be performed in the process 100 to further improve the properties of the coating 11 will now be described. It is specified that all or just some of these optional steps can be performed in the process 100.

The process 100 can comprise a surface treatment 102 of the spring 1, prior to the depositing step 104.

The surface treatment 102 can comprise a phosphating step 102A.

The phosphating step 102A leads to the formation, on the surface of the spring 1, of a layer of phosphate crystals. Therefore, on completion of the process 100, between the coating 11 and the surface of the spring 1, the spring 1 comprises a layer 40 of phosphate crystals as shown schematically in FIG. 3.

“Phosphate crystals” means crystals of the phosphate anion (PO₄)³⁻ with one or more metallic cations. In some embodiments the phosphate crystals comprise crystals of the phosphate anion (PO₄)³⁻ with cations of zinc (Zn²⁺) and manganese (Mn²⁺). In other embodiments, the phosphate crystals comprise crystals of the phosphate anion (PO₄)³⁻ with cations of zinc (Zn²⁺), manganese (Mn²⁺) and nickel (Ni²⁺).

The phosphating step 102A can comprise any appropriate method of phosphating. Phosphating methods are known per se and are therefore not described in detail here.

The layer 40 of phosphate crystals greatly improves adhesion of the matrix 11E to the surface of the spring 1.

The phosphate crystals of the layer 40 have an average size by number at most equal to 20 μm. Preferably, however, the phosphate crystals of the layer 40 have an average size by number at most equal to 10 μm. Because they are smaller in size, phosphate crystals better resist constraints undergone by the coating 11 during impact by gravel, improving resistance of the coating 11 to pitting.

The surface mass of the layer of phosphate crystals can be between 1.5 g/m² and 4 g/m², and preferably between 2.0 g/m² and 3.5 g/m². The expression “surface mass” designates the ratio between the mass of phosphate crystals deposited on the spring 1 and the surface of the spring 1.

After the phosphating step 102A the surface treatment 102 can also comprise a passivation step 102B.

The passivation step 102B leads to the formation, on the phosphate crystals, of a layer 30 of silanes and/or of substituted silanes. Therefore, on completion of the process 100, between the coating 11 and the layer 40 of phosphate crystals, the spring 1 comprises a layer of silanes and/or of substituted silanes 30 as shown schematically in FIG. 3.

The layer 30 can comprise one or more silanes, one or more substituted silanes, or a mixture of one or more silanes with one or more substituted silanes. “Silane” means designating any chemical linear or branched compound of formula SiₙH₂ₙ₊₂, where n is a whole number. Therefore, monosilane SiH₄ is an example of silane. “Substituted silane” means a silane wherein at least one hydrogen atom is replaced by another atom or a functional group. Therefore, a halosilane such as trichlorosilane or an organosilane such as methylsilane is a substituted silane.

The passivation step 102B can comprise any appropriate method to result in formation of the layer 30.

The layer 30 further protects adhesion of the matrix 11E on the surface of the spring 1.

After the phosphating step 102A and/or the passivation step 102B, a drying step 102C can be performed, during which evaporation of water having served as the phosphating step 102A and/or the passivation step 102B is caused. This drying can be executed by heating the spring 1 and/or by having the spring 1 enter an atmosphere with reduced pressure.

Also, prior to the phosphating step 102A and/or the passivation step 102B, a cleaning step 102-1 of the surface of the spring and/or a step 102-2 for activation of the surface of the spring can be performed. The step 102-2 can lead to the formation of sites favouring the formation of phosphate crystals of the layer 40.

### EXAMPLES

Exemplary embodiments according to this presentation will be described below. It is recalled that the invention is not limited to these examples.

### Example 1

In this example, six identical springs 6-1 to 6-6 have been provided. The springs 6-1 to 6-6 are front axle springs, made of grade 54SiCr6 steel, having a wire diameter of 14 mm and a total weight of around 2140 g. The springs 6-1 to 6-6 then underwent the following steps, performed identically for each spring:
shot peening;
cleaning of the surface of the spring;
activation of the surface of the spring;
phosphating resulting in the formation, on the surface of the spring, of a layer of phosphate crystals of average size less than 5 μm, the layer of phosphate crystals having a surface mass between 2.0 and 2.4 g/m²;
passivation resulting in the formation, on the phosphate crystals, of a layer of silanes;
drying of the spring to a temperature of around 120° C.;
preheating, carried out as follows: the spring is heated in a hot-air spraying oven until its surface reaches a temperature of around 190° C., then removed from the oven and conveyed to the deposit station of cross-linkable composition;
depositing on the preheated surface of the spring of a cross-linkable composition in the form of powder described hereinbelow. The deposit was made manually by electrostatic projection with corona effect, the preheated surface of the spring having a minimal temperature of 140° C. on completion of the depositing step;
heating of the spring in a hot-air spraying oven, the surface of the spring having a temperature of around 165° C. so as to cross-link the composition, therefore resulting in the coating.

A different quantity of cross-linkable composition was deposited on each spring so as to obtain the thicknesses specified in table 1 hereinbelow. The cross-linkable composition, in the form of powder prior to the depositing step, exhibited the following characteristics:
epoxy compound: obtained by reaction of bisphenol A with epichlorhydrin (EEW=around 800 g/equiv.);
synthetic mineral fibre filler of a length between 100 μm and 150 μm;
silica filler: pyrolyzed cristobalite filler constituted by around 99% in mass of silica (SiO₂), and having a median diameter in mass of around 15 μm measured by screening according to the standard NF P18-560;
first ceramic filler: substantially spherical borosilicate glass ball filler, having a median diameter in mass of around 55 μm measured by screening;
second ceramic filler: substantially spherical borosilicate glass ball filler, having a median diameter in mass of around 15 μm measured by screening;
hardener: bisphenol A, in stoichiometric proportions with the epoxy compound;
additive: around 1.0% in mass of carbon black.

After coating, the springs 6-1 to 6-6 were subjected to a pitting test according to the protocol SAE J400 in its revision effective June 2007.

The protocol SAE 3400 is a standardised protocol very well known in the field of springs for vehicle suspension. The complete description of this protocol is available from the US-based standards organisation “Society of Automotive Engineers”. It can be carried out at different surface temperatures of the spring, the lowest of which is −30° C. A lower surface temperature of the spring makes the pitting test severer, as a lower temperature diminishes the suppleness of the coating and therefore its resistance to impact by gravel.

In the present case, prior to the pitting test, the springs were placed in a freezer at −36° C. for 24 hours, then placed in the gravelometer such that the pitting test starts as soon as the surface of the spring reaches a temperature of −30° C., as described in the protocol SAE 32800.

Similarly, the protocol SAE 32800 is a standardised protocol, the complete description of which is available from the US-based standards organisation “Society of Automotive Engineers”.

After the pitting test described hereinabove, the springs 6-1 to 6-6 were subjected to a neutral salt spray corrosion test according to the standard ISO 9227:2012 for a period of 120 hours. The complete description of this standard is available from the “International Organization for Standardization” (ISO).

After the corrosion test described hereinabove, each of the springs 6-1 to 6-6 was examined visually to confirm whether it exhibited corrosion pits. The visual examination was first performed by the naked eye, then by means of a camera with enlargement up to 10×. The presence of a corrosion pit on a spring indicates that the coating has been damaged during the pitting test to the point of exposing the steel of the spring. The number of corrosion pits visible for each spring on completion of the corrosion test is specified in table 1 hereinbelow.

TABLE 1

| | Average thickness | Minimal thickness | |
|---|---|---|---|
| | of the deposited | of the deposited | Number of |
| Spring | coating | coating | corrosion pits |
| no. | (μm) | (μm) | on the spring |
| 6-1 | 508 | 236 | 0 |
| 6-2 | 545 | 262 | 1 |
| 6-3 | 646 | 348 | 0 |
| 6-4 | 665 | 364 | 0 |
| 6-5 | 682 | 386 | 0 |
| 6-6 | 690 | 428 | 0 |

It results from this example that a minimal thickness of coating at least equal to 350 μm lets coating resist the severest standardised pitting test currently available. It follows that the spring can also resist the standardised corrosion/fatigue pitting test (defined by the protocol SAE J2800) the severest currently available.

A minimal coating thickness at least equal to 200 μm but less than 350 μm is sufficient to resist less severe pitting tests.

### Example 2

In this example, a batch of identical platelets has been provided. “Platelets” here means thin sheets made of steel, having standardised dimensions and characteristics, intended for testing coatings. The platelets used in this example are sold under the reference “Q-PANEL R-48” by the company Q-LAB Corporation, and have the following characteristics: made of grade SAE 1008/1010 steel; matte finish surface, having a roughness Ra between 0.64 μm and 1.65 μm (between 25 and 65 micro-inches); length of 20.3 cm (8 inches); width of 10.2 cm (4 inches); thickness of 0.81 mm (0.032 inches) in the absence of any coating.

The platelets then underwent the following steps performed identically for each platelet:
cleaning of the surface of the platelet, by manual degreasing with methyl isobutyl ketone (MIBK; CAS No.: 108-10-1, ECHA No.: 100.003.228);
drying of the surface of the platelet in ambient air;
depositing on the surface of the platelet of a cross-linkable composition in the form of powder. The deposit was made manually by electrostatic projection with corona effect, the surface of the platelet being at ambient temperature during depositing;
heating of the platelet in a hot-air spray oven for 10 minutes to a temperature of 140° C., the surface of the platelet reaching a temperature of 140° C. after around 3 minutes so as to cross-link the composition, therefore resulting in the coating.

A similar quantity of cross-linkable composition was deposited on each platelet to produce a coating thickness of 120 μm (+/−10 μm) on each platelet. The cross-linkable composition, in the form of powder prior to the depositing step, is identical to that of the example 1 hereinabove.

After coating, the thickness of the coating was checked at 8 points as per the standard ISO 2808:2007, then the platelets were stored for 24 hours at a temperature of 23° C. (+/−2° C.) and at 50% (+/−5%) humidity. After this storage period of 24 hours, the platelets were subjected to standardised tests, with results recorded in table 2 below.

TABLE 2

| Tests | | Test results | |
|---|---|---|---|
| Impact test according to the | | 1. | No cracking or detachment |
| standard ASTM D2794-93 (2010) | | | of the coating was noted. |
| with an indenter diameter of | | 2. | No cracking or detachment |
| 15.9 mm: | | | of the coating was noted. |
| 1. | Direct impact (on the | | |
| | coated side of the | | |
| | platelet) at 10 N · m. | | |
| 2. | Indirect impact (on the | | |
| | non-coated side - opposite | | |
| | the coated side - of the | | |
| | platelet) at 10 N · m. | | |

| | |
|---|---|
| Erichsen Cupping test according | No cracking or detachment of |
| to the standard ISO 1520: 2006 | the coating was noted. |
| at a depth of 8 mm. | |
| Cross-cut adhesion test | GT 0 (that is: no detachment of |
| according to the standard ISO | the coating was noted). |
| 2409: 2013. | |
| Folding test (conical mandrel) | No cracking or detachment of |
| according to the ISO standard | the coating was noted. |
| 6860: 2006 with a mandrel of 3 | |
| mm diameter. | |
| Determination of the brightness | Brightness index at 60 degrees |
| index at 60 degrees according | measured at 80% (+/−5%). |
| to the standard ISO 2813: 2014. | |

The ASTM and ISO standards described hereinabove are standards very well known in the coatings sector. Complete descriptions of the ASTM standards are available from the US-based ASTM International Organisation, and complete descriptions of the ISO standards are available from the “International Organization for Standardization” (ISO).

It results from this example that the coating composition described in relation to example 1 produces a coating which has excellent mechanical performance with respect to deformations which are both slow (Erichsen cupping test according to the standard ISO 1520:2006, folding test (conical mandrel) according to the standard ISO 6860:2006) and rapid (impact test according to the standard ASTM D2794-93 (2010)), and excellent adhesion to its support (cross-cut adhesion test according to the standard ISO 2409:2013).

It is evident that these results are obtained even though the surface of the platelets has not been preheated. (Such preheating would not be practicable, since due to their thickness of less than 1 mm the platelets have insufficiently weak thermal inertia to control their surface temperature on completion of preheating.) But as explained hereinabove, the preheating step improves the general mechanical resistance of the coating. As a consequence, it must be expected that the coating of a suspension element according to this presentation has even better mechanical performance with respect to both slow and rapid deformation.

It also emerges from the test for determining the brightness index at 60 degrees according to the standard ISO 2813:2014 that the coating has a glossy finish, as indicated by the brightness value measured at 80%+/−5% at 60 degrees. This glossy finish is compatible with finish requirements of coatings for a vehicle suspension element.

Although the present invention has been described in reference to specific embodiments, modifications can be made to these examples without departing from the general scope of the invention such as defined by the claims. In particular, individual characteristics of the different embodiments illustrated/mentioned can be combined into additional embodiments. Consequently, the description and the drawings must be considered in an illustrative rather than a restrictive sense.

It is also evident that all the characteristics described in reference to a process are transposable singly or in combination to a product, and that inversely all the characteristics described in reference to a product are transposable singly or in combination to a process.

1-15. (canceled)

16. A vehicle suspension element provided with a coating, the coating comprising a reticulated polymer matrix comprising a polyepoxide and having a minimum thickness at least equal to 120 μm.

17. The vehicle suspension element according to claim 16, wherein the coating is constituted by a single layer deposited in a single depositing step.

18. The vehicle suspension element according to claim 16, wherein the coating comprises, in the reticulated polymer matrix:
a fibre filler of an average length by number at least equal to 100 μm;
a silica filler having a median diameter in mass at least equal to 1 μm;
a first ceramic filler having a median diameter in mass between 30 μm and 70 μm; and
a second ceramic filler having a median diameter in mass at least equal to 10 μm.

19. The vehicle suspension element according to claim 18, wherein said average length by number of the fibre filler is between 100 μm and 150 μm.

20. The vehicle suspension element according to claim 18, wherein fibres of the fibre filler have a length between 100 μm and 150 μm.

21. The vehicle suspension element according to claim 18, wherein fibres of the fibre filler have a diameter between 3 μm and 4 μm.

22. The vehicle suspension element according to 16, comprising, between the coating and the surface of the vehicle suspension element, a layer of phosphate crystals, the phosphate crystals having an average size by number at most equal to 20 μm.

23. The vehicle suspension element according to claim 22, comprising, between the coating and the layer of phosphate crystals, a layer of silanes and/or of substituted silanes.

24. The vehicle suspension element according to claim 16, wherein the vehicle suspension element is a helicoidal spring, a cambered stabilising bar, or a straight bar.

25. A process for depositing a coating on a vehicle suspension element, comprising:
providing the vehicle suspension element to be coated;
preheating the surface of the vehicle suspension element to a preheating temperature at least equal to 80° C.;
depositing on the preheated surface of the vehicle suspension element a cross-linkable composition comprising an epoxy compound;
heating the surface of the vehicle suspension element to a temperature greater than the preheating temperature so as to cross-link the composition, thereby resulting in the coating,
wherein the resulting coating has a minimum thickness at least equal to 120 μm.

26. The process according to claim 25, wherein the cross-linkable composition comprises:
a fibre filler of average length by number at least equal to 100 μm;
a silica filler having a median diameter in mass at least equal to 1 μm;
a first ceramic filler having a median diameter in mass between 30 μm and 70 μm; and
a second ceramic filler having a median diameter in mass at least equal to 10 μm.

27. The process according to claim 25, further comprising, prior to said depositing, forming, on the surface of the vehicle suspension element, a layer of phosphate crystals, the phosphate crystals having an average size by number at most equal to 20 μm.

28. The process according to claim 27, further comprising forming, on the phosphate crystals, a layer of silanes and/or of substituted silanes.

29. The process according to claim 25, wherein the cross-linkable composition is in the form of powder prior to said depositing, and wherein the depositing of said powder on the surface of the vehicle suspension element comprises electrostatic projection.

30. The process according to claim 25, wherein the cross-linkable composition further comprises at least one anticorrosion agent.
